(19) United States
(12) Patent Application Publication
(10) Pub. No.: US 2018/0146291 A1
(43) Pub. Date: May 24, 2018

(54) MULTIPLE AUDIO STEM TRANSMISSION

(71) Applicant: PERI, INC., Irvine, CA (US)

(72) Inventor: Mohammad TABATABAI, Newport Coast, CA (US)

(73) Assignee: PERI, INC., Irvine, CA (US)

(21) Appl. No.: 15/574,785

(22) PCT Filed: Feb. 24, 2016
(86) PCT No.: PCT/US2016/019424

§ 371 Date: Nov. 16, 2017

Related U.S. Application Data
(60) Provisional application No. 62/120,258, filed on Feb. 24, 2015.

(51) Int. Cl. H04R 3/12; G10L 19/00; H04R 27/00

(52) U.S. Cl. CPC H04R 3/12; H04R 2420/07; H04R 27/00; G10L 19/00

(57) ABSTRACT

A system for playing audio recordings includes a transmitter configured to separately encode and transmit each of a plurality of components of an audio recording to a plurality of receivers each configured to receive and decode one of the encoded components of the audio recording. In another embodiment, a method for playing audio recordings includes encoding each of a plurality of components of an audio recording, assigning each of the plurality of components to a specific receiver, transmitting each of the encoded components to the assigned receiver, decoding each of the encoded components and outputting each of the decoded components.

### CROSS-REFERENCE TO RELATED APPLICATIONS

This application claims the benefit of and priority to U.S. Provisional Patent Application Ser. No. 62/120,258, entitled MULTIPLE AUDIO STEM TRANSMISSION (MAST) and filed Feb. 24, 2015, the entire disclosure of which is incorporated herein by reference, to the extent that it is not conflicting with the application.

### BACKGROUND

This invention relates to transmission of audio data/content through Radio Frequency modulation schemes used such as Bluetooth, WiFi or any other method which may have sufficient Bandwidth to transport individual stems, submixes, subgroups or busses to receiving devices that are then enabled or programmed to decode the transmitted packet to play each stem separately or mix each stem or subgroup in order to form a specific custom tailored mix. This invention is in the spirit of Hi Resolution Audio and allows audiophiles and music lovers to create personal hearing experiences of their own using the source stem files.

### SUMMARY

The present application describes various methods for transmitting audio content through radio frequency modulation to multiple receivers.

In an exemplary embodiment of the invention, a system for playing audio recordings includes a transmitter configured to separately encode and transmit each of a plurality of components of an audio recording to a plurality of receivers each configured to receive and decode one of the encoded components of the audio recording.

In another embodiment, a method for playing audio recordings includes encoding each of a plurality of components of an audio recording, assigning each of the plurality of components to a specific receiver, transmitting each of the encoded components to the assigned receiver, decoding each of the encoded components and outputting each of the decoded components.

### BRIEF DESCRIPTION OF THE DRAWINGS

Features and advantages of the general inventive concepts will become apparent from the following detailed description made with reference to the accompanying drawings.

FIG. 1 is a schematic diagram of an embodiment of the present application;

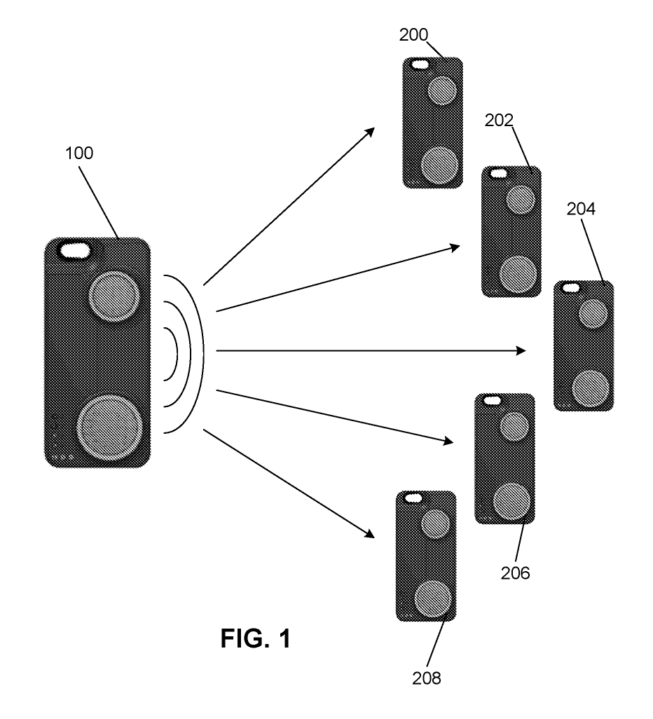

FIG. 2 is a schematic diagram of another embodiment of the present application; and

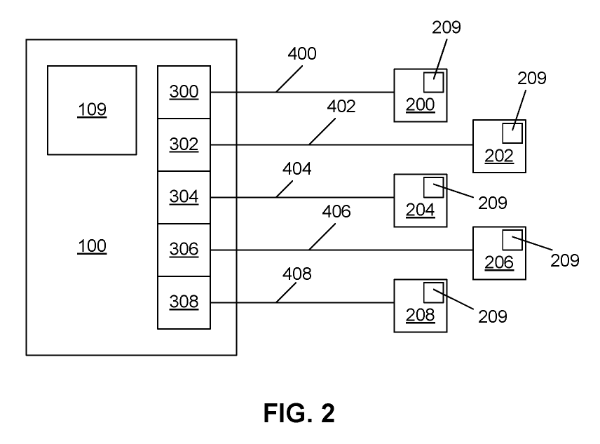

FIG. 3 is a schematic diagram of a further embodiment of the present application.

### DETAILED DESCRIPTION

This Detailed Description merely describes exemplary embodiments in accordance with the general inventive concepts and is not intended to limit the scope of the invention in any way. Indeed, the invention as described in the specification is broader than and unlimited by the exemplary embodiments set forth herein, and the terms used herein have their full ordinary meaning.

The general inventive concepts will now be described with occasional reference to the exemplary embodiments of the invention. This general inventive concept may, however, be embodied in different forms and should not be construed as limited to the embodiments set forth herein. Rather, these embodiments are provided so that this disclosure will be thorough and complete, and will fully convey the scope of the general inventive concepts to those skilled in the art.

Unless otherwise defined, all technical and scientific terms used herein have the same meaning as commonly understood by one of ordinary skill in the art encompassing the general inventive concepts. The terminology set forth in this detailed description is for describing particular embodiments only and is not intended to be limiting of the general inventive concepts.

The present invention is directed to a method for transmitting audio content through radio frequency modulation to multiple receivers.

In audio production, a stem is a group of audio sources mixed together to be dealt with downstream as one unit. A single stem may be delivered in mono, stereo, or in multiple tracks for surround sound. A person skilled in the art may understand that a stem in some embodiments may be any of digitally mixed audio files, such as MP3, MPEG4, WAV, RIFF, IFF, AIFF, LPCM and other compressed or uncompressed files. In some another embodiments, a stem even could be some type older file, which is digitally mastered and remixed for audio replay. In some embodiments, Submixes, Subgroups, or Busses should be considered as stems.

In some embodiments of the present subject matter, a transmitter 100 and a plurality of receivers 200, 202, 204, 206, 208 are provided. A person skilled in the art should understand the transmitter could be a computer, phone, phone case, tablet, or any other devices equipped with WiFi, Bluetooth or other modulation techniques. A person skilled in the art should understand that the receivers are not limited to the five receivers shown. A person skilled in the art should understand the receivers could be phones, phone cases, home theater system components, or public audio systems equipped with WiFi, Bluetooth or other modulation techniques.

In some embodiments, both the transmitter 100 and the receivers 200, 202, 204, 206, 208 have one or more types of radio frequency modulation. For example, the transmitter 100 and the receivers 200, 202, 204, 206, 208 may have WiFi, Bluetooth, or other modulation techniques. In some embodiments, the transmitter 100 comprises a transmitter controller 109. In some embodiments, each of receivers 200, 202, 204, 206, 208 comprises a receiver controller 209. In some embodiments, the transmitter controller 109 is configured to respectively encode multiple stems and to assign each encoded stem to different receivers. For example, in some embodiments, the transmitter controller 109 assigns the stem 300 to the receiver 200, the stem 302 to the receiver 202, the stem 304 to the receiver 204, the stem 306 to the receiver 206, and the stem 308 to the receiver 208.

In some embodiments, the transmitter 100 transmits the stems 300, 302, 304, 306, 308 to all receivers via the same protocol. In some embodiments the transmitter 100 transmits the stems to different receivers via different protocols. A person skilled in the art should understand the protocol includes but are not limited to WiFi, Bluetooth, ZigBee, or any other suitable wireless transmission protocols. In some embodiments, for example, the transmitter 100 transmits the stem 300 to the receiver 200 via WiFi protocol 400; the transmitter 100 transmits the stem 302 to the receiver 202 via Bluetooth 402; the transmitter 100 transmits the stem 304 to the receiver 204 via ZigBee 404; the transmitter 100 transmits the stem 306 to the receiver 206 via WiFi 406.

In some embodiments, when the receiver 200, 202, 204, 206, 208 receives the encoded stem, the receiver controller 209 is configured to decode the encoded stem. The receiver controller 209 then is configured to output the decoded stems. In some embodiments, the receiver controller 209 outputs the decoded stem to the embodied speakers of the receiver. In some embodiments, the receiver controller 209 outputs the decoded stem to outside devices, such as active speakers.

In some embodiments of the present subject matter, the transmittal controller 109 assigns a predetermined time value to each stem. In some embodiments, the transmittal controller 109 assigns a predetermined phase value to each stem. In some embodiments, the transmittal controller 109 assigns a predetermined amplitude value to each stem.

In some embodiments, the transmittal controller 109 adjusts the time, phase, or amplitude to transmit a stem based on the assigned time or phase values. In some embodiments, the receiver controller 209 adjusts the time, phase, or amplitude to output of a stem based on the assigned time or phase values.

In some embodiments, the time, phase, or amplitude values are calculated based on the modulation techniques used on the particular stem. In some embodiments, the time, phase, or amplitude values are calculated based on the distances between the transmitter 100 and each receiver 200. In some embodiments, the time, phase, or amplitude values are calculated based on actual feedback between the transmitter 100 and each receiver 200.

In some embodiments, the time, phase, or amplitude values are calculated so that all receivers 200, 202, 204, 206, 208 are configured to output all stems synchronously so as to avoid unwanted delays caused by the hardware or the transmittal protocols.

In some embodiments, the time, phase, or amplitude values are calculated so that receivers 200, 202, 204, 206, 208 are configured to output all stems purposely at different delays, i.e., not synchronously, so as to create sonic depth perceptions.

In some embodiments, the time, phase, or amplitude values are calculated so that receivers 200, 202, 204, 206, 208 are configured to output all stems purposely at different delays, i.e., not synchronously, so as to create perceptions of relative spaces for each musical instrument or audio content.

In some embodiments, the time, phase, or amplitude values are not calculated in the transmittal controller 109. Rather, a user may input at least one of the time, phase, or amplitude values to the transmittal controller 109 directly or via a wired or wireless connection.

The current invention uses the currently available stem sources in digital format and assigns them to WiFi, Bluetooth or other types of transmission packets and through a networked connectivity of multiple speakers that plays each stem file synchronously at each speaker. The invention thus allows for each musical instrument (Guitar, Bass Drum, Violin, Piano or other instruments) to play separately and synchronously on different speakers as part of the original music piece.

Through use of an iOS, android App or the like, the stems could be combined to create new mixes and files that contain the original instruments digital recordings. This new file and new mix could also be played on a single speaker as one compressed or uncompressed file.

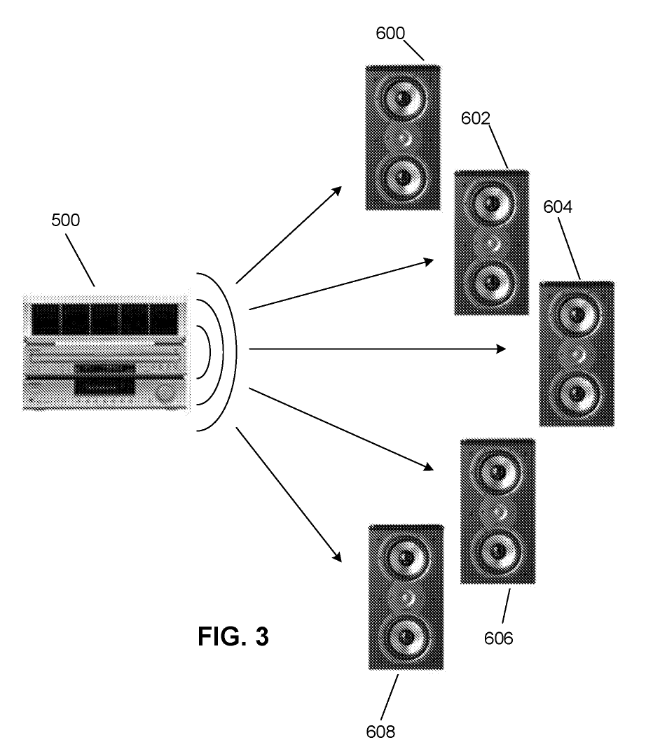

FIG. 3 shows one further specific embodiment of the present invention, though one of ordinary skill would understand that the invention is not limited to this embodiment. In the embodiment of FIG. 3, a home theater system 500 acts as the transmitter to a plurality of wireless or wired speakers 600, 602, 604, 606, 608, which are receivers. The home theater system may transmit a wireless signal via WiFi, Bluetooth or other modulation techniques to the speakers 600, 602, 604, 606, 608.

While the present invention has been illustrated by the description of embodiments thereof, and while the embodiments have been described in considerable detail, it is not the intention of the applicants to restrict or in any way limit the scope of the invention to such details. Additional advantages and modifications will readily appear to those skilled in the art. For example, where components are releasable or removably, connected or attached together, any type of releasable connection may be suitable including for example, locking connections, fastened connections, tongue and groove connections, etc. Still further, component geometries, shapes, and dimensions can be modified without changing the overall role or function of the components. Therefore, the inventive concept, in its broader aspects, is not limited to the specific details, the representative apparatus, and illustrative examples shown and described. Accordingly, departures may be made from such details without departing from the spirit or scope of the applicant's general inventive concept.

Further, while various inventive aspects, concepts and features of the general inventive concepts are described and illustrated herein in the context of various exemplary embodiments, these various aspects, concepts, and features may be used in many alternative embodiments, either individually or in various combinations and sub-combinations thereof. Unless expressly excluded herein all such combinations and sub-combinations are intended to be within the scope of the general inventive concepts. Still further, while various alternative embodiments as to the various aspects, concepts, and features of the inventions (such as alternative materials, structures, configurations, methods, devices and components, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some aspects, concepts, and features of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, concepts, and features may be expressly identified herein as being inventive or forming part of an invention, such identification is not intended to be exclusive, but rather there may be inventive aspects, concepts, and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed is:

1. A system for playing audio recordings comprising:
a transmitter configured to separately encode and transmit each of a plurality of components of an audio recording to a plurality of receivers each configured to receive and decode one of the encoded components of the audio recording.

2. The system of claim 1 wherein the transmitter is further configured to assign each of the plurality of components to a specific receiver.

3. The system of claim 1 wherein transmitter is configured to transmit each component of the plurality of components using any one of a plurality of wireless transmission protocols.

4. The system of claim 1 wherein a receiver of the plurality of receivers is further configured to output the decoded component.

5. The system of claim 1 wherein a receiver of the plurality of receivers is further configured to transmit the decoded component to another device for output.

6. The system of claim 1 wherein the transmitter is further configured to assign a predetermined shift value to a component of the plurality of components.

7. The system of claim 6 wherein the predetermined shift value is one of a time, a phase or an amplitude.

8. The system of claim 6 wherein the predetermined shift value for a component is based on a wireless transmission protocol used to transmit that component.

9. The system of claim 6 wherein the predetermined shift value for a component is configured to create a sonic depth perception.

10. The system of claim 6 wherein the predetermined shift value for a component is configured to create a distinct auditory space for each component.

11. A method for playing audio recordings comprising:
encoding each of a plurality of components of an audio recording;
assigning each of the plurality of components to a specific receiver;
transmitting each of the encoded components to the assigned receiver;
decoding each of the encoded components; and
outputting each of the decoded components.

12. The method of claim 11 wherein different components are transmitted using different wireless communication protocols.

13. The method of claim 11 wherein decoded component is output by the assigned receiver.

14. The method of claim 11 further wherein the decoded component is transmitted to another device for output.

15. The method of claim 11 further comprising assigning a predetermined shift value to a component of the plurality of components.

16. The method of claim 15 wherein the predetermined shift value is one of a time, a phase or an amplitude.

17. The method of claim 15 wherein the predetermined shift value for a component is based on a wireless transmission protocol used to transmit that component.

18. The method of claim 15 wherein the predetermined shift value for a component is configured to create a sonic depth perception.

19. The method of claim 15 wherein the predetermined shift value for a component is configured to create a distinct auditory space for each component.

20. The method of claim 11 further comprising recording the sum of outputs of the decoded components and storing the recorded output.
